(19) United States
(12) Patent Application Publication
(10) Pub. No.: US 2009/0015662 A1
(43) Pub. Date: Jan. 15, 2009

(54) METHOD AND APPARATUS FOR ENCODING AND DECODING STEREOSCOPIC IMAGE FORMAT INCLUDING BOTH INFORMATION OF BASE VIEW IMAGE AND INFORMATION OF ADDITIONAL VIEW IMAGE

(75) Inventors: Yong-tae Kim, Seoul (KR); Jae-seung Kim, Yongin-si (KR); Seong-sin Joo, Suwon-si (KR); Dae-sik Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/163,245

(22) Filed: Jun. 27, 2008

Related U.S. Application Data
(60) Provisional application No. 60/949,565, filed on Jul. 13, 2007.

(30) Foreign Application Priority Data
Aug. 31, 2007 (KR) 10-2007-0088303

(51) Int. Cl. H04N 13/00

(52) U.S. Cl. 348/43; 348/E13.001

(57) ABSTRACT

Provided are a method and apparatus for encoding and decoding a stereoscopic image format. The method includes generating a combined image by combining a base view image and an additional view image, generating a depth map between the base view image and the additional view image, generating a first YUV format using the combined image, and generating a second YUV format using the depth map.

### CROSS-REFERENCE TO RELATED PATENT APPLICATION

This application claims the benefit of Korean Patent Application No. 10-2007-0088303, filed on Aug. 31, 2007, in the Korean Intellectual Property Office, and the benefit of U.S. Provisional Patent Application No. 60/949,565, filed on Jul. 13, 2007, in the U.S. Patent and Trademark Office, the disclosures of which are incorporated herein in their entirety by reference.

### BACKGROUND OF THE INVENTION

1. Field of the Invention

Methods and apparatuses consistent with the present invention generally relate to generating images in a stereoscopic image format from stereoscopic images, encoding the images in the stereoscopic image format, and reconstructing the stereoscopic images by decoding the images in the stereoscopic image format, and more particularly, to encoding and decoding images in a stereoscopic image format in which various information of stereoscopic images can be transmitted for accurate reconstruction of the stereoscopic images and efficient transmission can be performed.

2. Description of the Related Art

To date, many methods of transmitting stereoscopic images have been proposed. For example, for efficient transmission of stereoscopic images, standards such as Moving Picture Experts Group (MPEG)-2 Multiview Video Profile (MVP), depth map transmission using MPEG-4 Multiple Auxiliary Component (MAC), Multiview Video Coding (MVC) of MPEG-4 Advanced Video Coding (AVC)/H.264, and the like have been established.

For transmission of stereoscopic images, an image format may be generated using a left-view image and a right-view image in the unit of a field. The stereoscopic images may be a left-view image and a right-view image.

FIG. 1A illustrates a field-based stereoscopic image format. In FIG. 1A, input stereoscopic images, i.e., left view and right view images, are disposed in a vertical direction line by line and are then converted into a field-based stereoscopic image format for transmission and reception.

FIG. 1B is a block diagram of a transmitting end and a receiving end for a field-based stereoscopic image format.

Referring to FIG. 1B, a stereoscopic image pre-processor for generating and encoding an image in a field-based stereoscopic image format and a stereoscopic image post-processor for decoding a received image in a field-based stereoscopic image format to reconstruct stereoscopic images are illustrated. A left view image and a right view image converted to a field-based format are compressed by an MPEG encoder. Since MPEG standards other than MPEG-1 support field-based compression, the MPEG standards maintain compression efficiency when performing block-based Discrete Cosine Transformation (DCT), motion estimation, and disparity estimation.

Conventional image formats including the field-based stereoscopic image format illustrated in FIG. 1A are not defined for a stereoscopic image pre-processor or a stereoscopic image post-processor. As a result, a left view image and a right view image are displayed one after another in the unit of a field when a field-based stereoscopic image format is decoded, causing a viewer to experience a serious flickering effect.

Furthermore, in the case of a multi-view image, the resolution of each of the multiple images in the multi-view image format of a single image, decreases as the number of views increases. Moreover, the compression efficiency of a combined image using such an multi-view image format degrades.

FIG. 2 illustrates a conventional stereoscopic image format for transmitting only a two-dimensional (2D) image and a depth map, i.e., a depth image.

Among standards for stereoscopic images, “Information Technology—MPEG Video Technologies—Part 3: Representation of Auxiliary Video and Supplemental Information” prescribes a method of transmitting depth information. In this standard, a 2D image and corresponding depth information are transmitted. A conventional stereoscopic image transmission scheme like this standard allocates a channel to each of a 2D image 210 in color and a depth map 220 in grayscale, for transmission.

FIG. 3A is a diagram for describing a conventional method of obtaining a stereoscopic image format.

A multi-view image is photographed by a plurality of cameras from multiple views as illustrated in FIG. 3A. In other words, since objects 310, 320, and 330 are photographed from different views by cameras 340, 350, and 360, they are photographed from different angles.

FIG. 3B shows a problem of the conventional stereoscopic image format illustrated in FIG. 3A.

Referring to FIG. 3B, images 370, 380, and 390 are obtained by the photographing operations described with reference to FIG. 3A. In other words, the image 390 is photographed by the camera 340, the image 380 is photographed by the camera 350, and the image 370 is photographed by the camera 360.

As can be seen from the images 370, 380, and 390, if only one of the images 370, 380, and 390, which has been photographed from a certain view, is transmitted, information of an occlusion area cannot be reconstructed even with disparity/depth information. As a result, the conventional method in which only a 2D image and a depth map are transmitted causes many problems in rendering for an occlusion region.

### SUMMARY OF THE INVENTION

The present invention provides a method and apparatus for encoding and decoding images in a stereoscopic image format in which both information of all views of stereoscopic images and disparity/depth information are transmitted for accurate reconstruction of the stereoscopic images and efficient transmission can be performed.

Since information of an occlusion area cannot be reconstructed only with a 2D image and disparity/depth information from a single view, information of a base view image and information of an additional view image are required. Thus, the present invention also provides an image format which includes information of a base view image, information of an additional view image, and disparity/depth information, but can be transmitted through two channels like in a conventional image format.

The present invention also provides a method of using motion information as well as disparity/depth information for accurate and efficient encoding and decoding.

According to one aspect of the present invention, there is provided a method of encoding images in a stereoscopic image format. The method includes generating a combined image by combining a base view image and an additional view image, generating a depth map between the base view image and the additional view image, generating a first YUV format image using the combined image, and generating a second YUV format image using the depth map, where the Y is the luminance component and UV are the two chrominance components.

The generation of the combined image may include generating a combined image that includes pixel information of the base view image and pixel information of the additional view image and has the same resolution of that of the base view image and the additional view image.

The generation of the second YUV format image may include recording the depth map in a Y region of the second YUV format image and recording a specific value 128 or 0 in a U region and a V region of the second YUV format image.

The generation of the second YUV format image may include reducing the resolution of each of the Y region, the U region, and the V region of the second YUV format image by ½ in a horizontal direction or in a vertical direction.

According to another aspect of the present invention, there is provided a method of encoding stereoscopic image format images. The method includes generating a depth map between a base view image and an additional view image and a motion map of the additional view image, generating a differential image between the base view image and the additional view image, generating a first YUV format image using the base view image, and generating a second YUV format image using the differential image and the depth map or the motion map.

The generation of the differential image may include generating the differential image between a base view image obtained by encoding the base view image and then decoding the encoded base view image and the additional view image.

The generation of the second YUV format image may include determining which one of a variance of the depth map and a variance of the motion map is smaller, generating the second YUV format image using the depth map if the variance of the depth map is determined to be smaller, generating a first frame of the second YUV format image using a depth map between a first frame of the base view image and a first frame of the additional view image, and generating a plurality of remaining frames of the second YUV format image using the motion map of a plurality of remaining frames of the additional view image.

The generation of the second YUV format image may include recording luminance information, i.e., Y information, of the differential image in a Y region of the second YUV format image, recording the depth map or the motion map in one of a U region and a V region of the second YUV format image, and recording chrominance information, i.e., U information and V information, of the differential image in the other one of the U region and the V region of the second YUV format image.

The generation of the second YUV format image may include recording the depth map or the motion map in a Y region of the second YUV format image, recording Y information of the differential image in one of a U region and a V region of the second YUV format image, and recording U information and V information of the differential image in the other one of the U region and the V region of the second YUV format image.

According to another aspect of the present invention, there is provided a method of encoding images in a stereoscopic image format. The method includes generating a depth map between a base view image and an additional view image, generating a first YUV format image using the base view image, generating a second YUV format image using the additional view image, and generating a third YUV format image using the depth map.

The generation of the third YUV format image may include recording the depth map in a Y region of the third YUV format image and recording a specific value 128 or 0 in a U region and a V region of the third YUV format image.

According to another aspect of the present invention, there is provided a method of decoding images in a stereoscopic image format. The method includes extracting combined image information including a base view image and an additional view image from a received first YUV format image, extracting a depth map between the base view image and the additional view image from a received second YUV format image, and reconstructing the base view image and the additional view image using the extracted combined image information and the extracted depth map.

The extraction of the depth map may include, if the second YUV format image is a reduced format, increasing the resolution of the second YUV format image to the original resolution and extracting the depth map from a Y region of the second YUV format image.

The reconstruction of the base view image and the additional view image may include reconstructing fractional information of the base view image and fractional information of the additional view image from the extracted combined image information and reconstructing the base view image and the additional view image to their original resolution using the reconstructed fractional information of the base view image, the reconstructed fractional information of the additional view image, and the depth map.

According to another aspect of the present invention, there is provided a method of decoding images in a stereoscopic image format. The method includes extracting base view image information from a received first YUV format image, extracting differential image information between a base view image and an additional view image and a depth map between the base view image and the additional view image or a motion map of the additional view image from a received second YUV format image, and reconstructing the base view image and the additional view image using the extracted base view image information, the extracted differential image information, and the extracted depth map or motion map.

The extraction from the second YUV format image may include extracting Y information of the differential image information from a Y region of the second YUV format image, extracting the depth map or the motion map from one of a U region and a V region of the second YUV format image, and extracting chrominance information, i.e., U information and V information, from the other one of the U region and the V region of the second YUV format image.

The extraction from the second YUV format image may include extracting the depth map or the motion map from a Y region of the second YUV format image, extracting Y information of the differential image information from one of a U region and a V region of the second YUV format image, and extracting U information and V information of the differential image information from the other one of the U region and the V region of the second YUV format image.

The reconstruction of the base view image and the additional view image may include, if only the depth map is received, reconstructing the additional view image using the depth map and the extracted base view image information, and if the depth map and the motion map are received, reconstructing a first frame of the additional view image using the depth map and a first frame of the extracted base view image information and reconstructing other frames of the additional view image using the motion map and the reconstructed first frame of the additional view image.

According to another aspect of the present invention, there is provided a method of decoding images in a stereoscopic image format. The method includes extracting base view image information from a received first YUV format image, extracting additional view image information from a received second YUV format image, extracting a depth map from a received third YUV format image, and reconstructing a base view image and an additional view image using the extracted base view image information, the extracted additional view image, and the extracted depth map.

The extraction from the third YUV format image may include extracting the depth map from a Y region of the third YUV format image.

According to another aspect of the present invention, there is provided an apparatus for encoding images in a stereoscopic image format. The apparatus includes a combined image generation unit generating a combined image by combining a base view image and an additional view image, a depth map generation unit generating a depth map between the base view image and the additional view image, a first YUV format generation unit generating a first YUV format image using the combined image, and a second YUV format generation unit generating a second YUV format image using the depth map.

According to another aspect of the present invention, there is provided an apparatus for encoding images in a stereoscopic image format. The apparatus includes a depth map/motion map generation unit generating a depth map between a base view image and an additional view image and a motion map of the additional view image, a differential image generation unit generating a differential image between the base view image and the additional view image, a first YUV format generation unit generating a first YUV format image using the base view image, and a second YUV format generation unit generating a second YUV format image using the differential image and the depth map or the motion map.

According to another aspect of the present invention, there is provided an apparatus for encoding images in a stereoscopic image format. The apparatus includes a depth map generation unit generating a depth map between a base view image and an additional view image, a first YUV format generation unit generating a first YUV format image using the base view image, a second YUV format generation unit generating a second YUV format image using the additional view image, and a third YUV format generation unit generating a third YUV format image using the depth map.

According to another aspect of the present invention, there is provided an apparatus for decoding images in a stereoscopic image format. The apparatus includes a combined image extraction unit extracting combined image information composed of a base view image and an additional view image from a received first YUV format image, a depth map extraction unit extracting a depth map between the base view image and the additional view image from a received second YUV format image, and a reconstruction unit reconstructing the base view image and the additional view image using the extracted combined image information and the extracted depth map.

According to another aspect of the present invention, there is provided an apparatus for decoding images in a stereoscopic image format. The apparatus includes a first YUV format extraction unit extracting base view image information from a received first YUV format image, a second YUV format extraction unit extracting differential image information between a base view image and an additional view image and a depth map between the base view image and the additional view image or a motion map of the additional view image from a received second YUV format image, and a reconstruction unit reconstructing the base view image and the additional view image using the extracted base view image information, and the extracted differential image information, and the extracted depth map or motion map.

According to another aspect of the present invention, there is provided an apparatus for decoding images in a stereoscopic image format. The apparatus includes a first YUV format extraction unit extracting base view image information from a received first YUV format image, a second YUV format extraction unit extracting additional view image information from a received second YUV format image, a third YUV format extraction unit extracting a depth map from a received third YUV format image, and a reconstruction unit reconstructing a base view image and an additional view image using the extracted base view image information, the extracted additional view image, and the extracted depth map.

According to another aspect of the present invention, there is provided a computer-readable recording medium having recorded thereon a program for executing the method of encoding images in a stereoscopic image format.

According to another aspect of the present invention, there is provided a computer-readable recording medium having recorded thereon a program for executing the method of decoding images in a stereoscopic image format.

### BRIEF DESCRIPTION OF THE DRAWINGS

The above and other features of the present invention will become more apparent by describing in detail exemplary embodiments thereof with reference to the attached drawings in which:

FIG. 1A illustrates a field-based stereoscopic image format;

FIG. 1B is a block diagram of a transmitting end and a receiving end of a field-based stereoscopic image format;

FIG. 2 illustrates a conventional stereoscopic image format for transmitting only a two-dimensional (2D) image and a depth map;

FIG. 3A is a diagram for describing a conventional method of obtaining images in a stereoscopic image format;

FIG. 3B shows a problem of the conventional stereoscopic image format described with reference to FIG. 3A;

FIG. 4A is a block diagram of an apparatus for encoding images in a stereoscopic image format, according to an embodiment of the present invention;

FIG. 4B is a block diagram of an apparatus for decoding images in a stereoscopic image format according to an embodiment of the present invention;

FIG. 5 illustrates a system for transmitting and receiving images in a stereoscopic image format, according to an embodiment of the present invention;

FIGS. 6A through 6C illustrate images in a stereoscopic image format according to exemplary embodiments of the present invention;

FIG. 7A is a block diagram of an apparatus for encoding images in a stereoscopic image format, according to another embodiment of the present invention;

FIG. 7B is a block diagram of an apparatus for decoding images in a stereoscopic image format, according to another embodiment of the present invention;

FIG. 8 illustrates a system for transmitting and receiving images in a stereoscopic image format, according to another embodiment of the present invention;

FIGS. 9A and 9B illustrate a relationship among a base view image, an additional view image, and a depth map according to exemplary embodiments of the present invention;

FIGS. 10A through 10C illustrate images in a stereoscopic image format according to exemplary embodiments of the present invention;

FIG. 11A is a block diagram of an apparatus for encoding images in a stereoscopic image format, according to another embodiment of the present invention;

FIG. 11B is a block diagram of an apparatus for decoding images in a stereoscopic image format, according to another embodiment of the present invention;

FIG. 12 illustrates images in a stereoscopic image format according to another exemplary embodiment of the present invention;

FIG. 13A is a flowchart illustrating a method of encoding images in a stereoscopic image format, according to an embodiment of the present invention;

FIG. 13B is a flowchart illustrating a method of decoding images in a stereoscopic image format, according to an embodiment of the present invention;

FIG. 14A is a flowchart illustrating a method of encoding images in a stereoscopic image format, according to another embodiment of the present invention;

FIG. 14B is a flowchart illustrating a method of decoding images in a stereoscopic image format, according to another embodiment of the present invention;

FIG. 15A is a flowchart illustrating a method of encoding images in a stereoscopic image format, according to another embodiment of the present invention; and

FIG. 15B is a flowchart illustrating a method of decoding images in a stereoscopic image format, according to another embodiment of the present invention.

### DETAILED DESCRIPTION OF THE INVENTION

Hereinafter, exemplary embodiments of the present invention will be described in detail with reference to the accompanying drawings. It should be noted that like reference numerals refer to like elements illustrated in one or more of the drawings. In the following description of the present invention, detailed description of known functions and configurations incorporated herein will be omitted for conciseness and clarity.

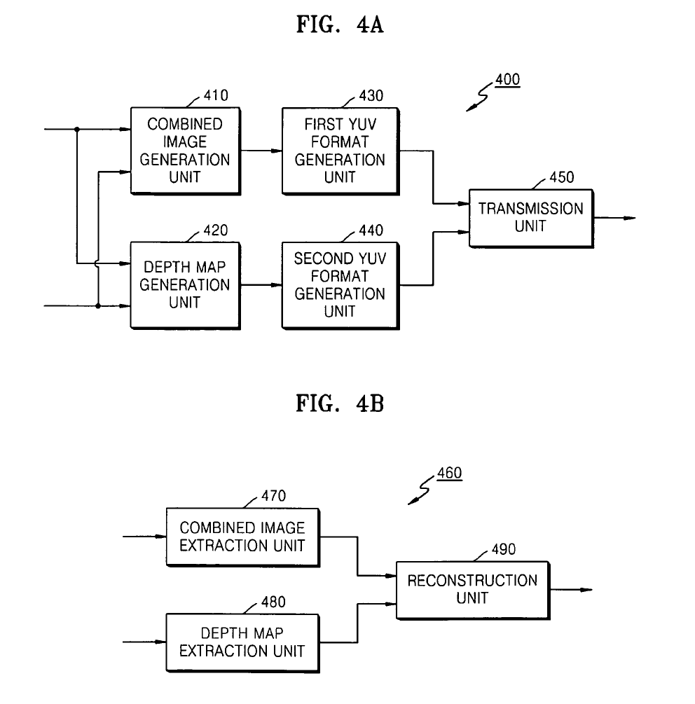

Hereinafter, an apparatus and method for encoding and decoding images in a stereoscopic image format will be described with reference to FIGS. 4A through 9B.

FIG. 4A is a block diagram of an apparatus 400 for encoding images in a stereoscopic image format, according to an embodiment of the present invention.

Referring to FIG. 4A, the apparatus 400 according to the current embodiment of the present invention includes a combined image generation unit 410, a depth map generation unit 420, a first YUV format generation unit 430, a second YUV format generation unit 440, and a transmission unit 450. Instead of the first and the second YUV format generation units 430, 440, there may be format generation units in different color spaces.

The combined image generation unit 410 receives a first image and a second image, e.g., a base view image and an additional view image, generates a combined image by combining information of the base view image and information of the additional view image, and outputs the combined image to the first YUV format generation unit 430.

According to the current embodiment of the present invention, the combined image generated by the combined image generation unit 410 includes pixel information of the base view image and pixel information of the additional view image and has the same resolution as that of the base view image and the additional view image.

According to the current embodiment of the present invention, the combined image generation unit 410 combines the information of the base view image and the information of the additional view image using a side-by-side scheme for disposing the base view image and the additional view image in left and right portions of the combined image, a top-bottom scheme for disposing the base view image and the additional view image in the top and down portions of the combined image, or a line-interleaved scheme for alternately disposing the base view image and the additional view image line by line.

The depth map generation unit 420 receives the base view image and the additional view image, generates a depth map between the base view image and the additional view image, and outputs the depth map to the second YUV format generation unit 440.

In an exemplary embodiment of the present invention, the depth map generation unit 420 generates the depth map using a disparity vector obtained by disparity estimation between the base view image and the additional view image. In another exemplary embodiment of the present invention, the depth map is generated using a depth camera device.

According to the current embodiment of the present invention, a disparity map may also be used in addition to the depth map generated using disparity estimation or a depth camera device.

The first YUV format generation unit 430 generates a first YUV format image using the combined image input from the combined image generation unit 410 and outputs the generated first YUV format image to the transmission unit 450. In another embodiment, a first format generation unit and a second format generation unit generate images in a color space other than the YUV color space.

The second YUV format generation unit 440 generates a second YUV format image using the depth map input from the depth map generation unit 420 and transmits the second YUV format image to the transmission unit 450.

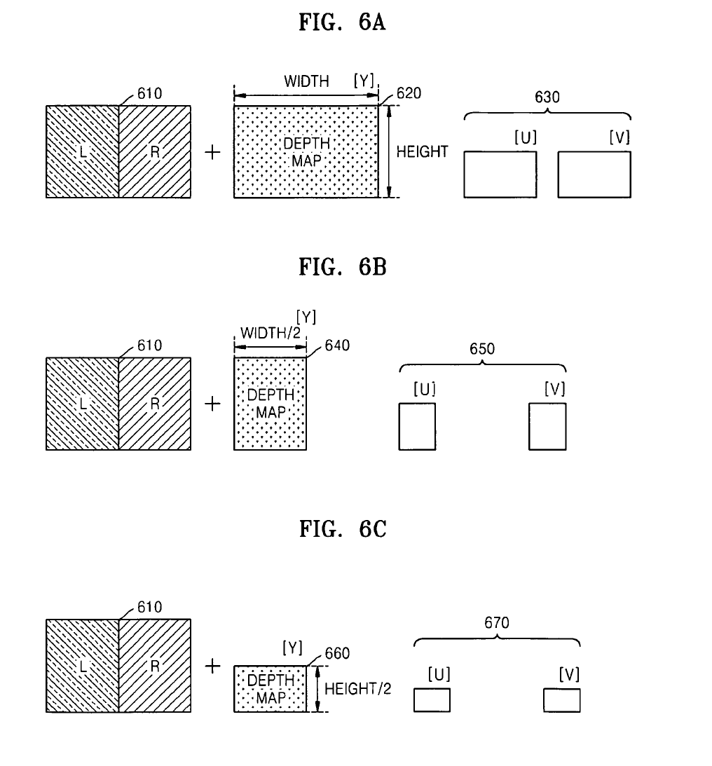

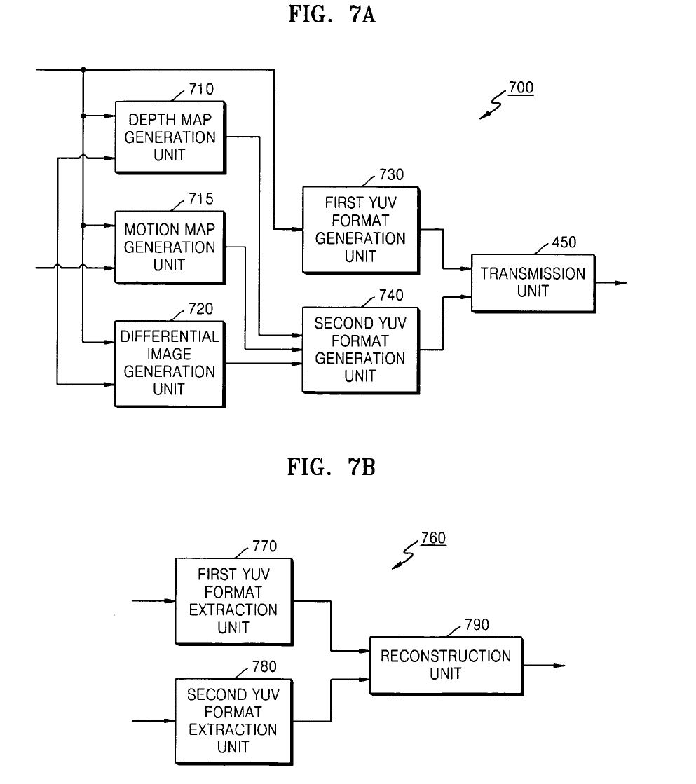

The operations of the first YUV format generation unit 430 and the second YUV format generation unit 440 will be described later in detail with reference to FIGS. 6A through 6C and FIG. 7.

The transmission unit 450 transmits the first YUV format image input from the first YUV format generation unit 430 to a base channel and transmits the second YUV format image input from the second YUV format generation unit 440 to an additional channel.

FIG. 4B is a block diagram of an apparatus 460 for decoding images in stereoscopic image format, according to an embodiment of the present invention.

Referring to FIG. 4B, the apparatus 460 according to the current embodiment of the present invention includes a combined image extraction unit 470, a depth map extraction unit 480, and a reconstruction unit 490.

The combined image extraction unit 470 extracts information of a combined image obtained by combining a base view image and an additional view image from a received first YUV format image and outputs the extracted combined image information to the reconstruction unit 490.

The depth map generation unit 480 extracts a depth map between the base view image and the additional view image from a received second YUV format image and outputs the extracted depth map to the reconstruction unit 490.

The operations of the combined image extraction unit 470 and the depth map generation unit 480 will be described later in detail with reference to FIGS. 6A through 6C and FIG. 7.

The reconstruction unit 490 reconstructs the base view image and the additional view image using the combined image information input from the combined image extraction unit 470 and the depth map input from the depth map extraction unit 480 and outputs the reconstructed base view image and additional view image.

According to the current embodiment of the present invention, the reconstruction unit 490 first reconstructs fractional information of the base view information and fractional information of the additional view image from the extracted combined image information. The base view image and the additional view image having their original resolution are reconstructed using the reconstructed fractional information of the base view image, the reconstructed fraction information of the additional view image, and the extracted depth map. At this time, the original resolution of the base view image and the additional view image is reconstructed by disparity compensation using disparity vector information of the depth map.

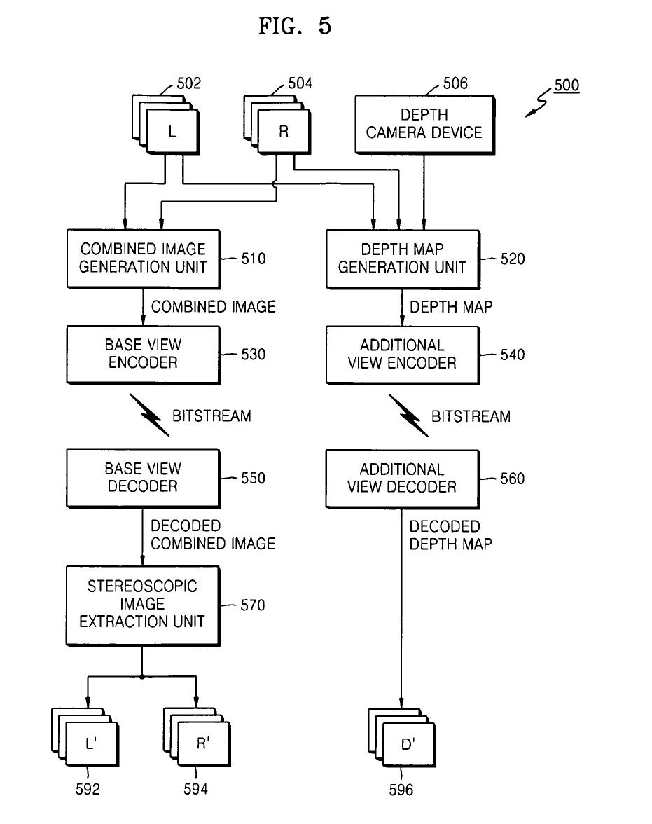

FIG. 5 illustrates a system 500 for transmitting and receiving a images in stereoscopic image format, according to an embodiment of the present invention.

Referring to FIG. 5, the system 500 according to the current embodiment of the present invention includes a sequence 502 which is a base view image sequence and a sequence 504 which is an additional view image sequence. In the current embodiment of the present invention, a base view image is a left view image and an additional view image is a right view image.

A sequence 592 is a reconstructed base view image sequence, a sequence 594 is a reconstructed additional view image sequence, and a sequence 596 is a reconstructed depth map sequence.

The system 500 according to the current embodiment of the present invention includes a depth camera device 506, a combined image generation unit 510, a depth map generation unit 520, a base view encoder 530, an additional view encoder 540, a base view decoder 550, an additional view decoder 560, and a stereoscopic image extraction unit 570.

The depth camera device 506, the combined image generation unit 510, and the depth map generation unit 520 perform the same functions as those of the depth camera device, the combined image generation unit 410, and the depth map generation unit 420 of the apparatus 400 illustrated in FIG. 4A according to the first exemplary embodiment of the present invention.

The base view encoding unit 530, the additional view encoding unit 540, the base view decoding unit 550, and the additional view decoding unit 560 of the system 500 are the same as those of a conventional system for transmitting and receiving images in a stereoscopic image format which allocates a channel to each of the base view image and the additional view image for transmission and reception.

The system 500 may use a conventional system for encoding and decoding stereoscopic images. In other words, a combined image generated by the combined image generation unit 510 (or 410) is encoded by the base view encoder 530 of the conventional system and the depth map generated by the depth map generation unit 520 (or 420) is encoded by the additional view encoder 540 of the conventional system.

Once each of the encoded combined image and the encoded depth map is allocated to a channel, the combined image is decoded by the base view decoder 550 of the conventional system and the depth map is decoded by the additional view decoder 560 of the conventional system.

The stereoscopic image extraction unit 570 extracts the base view image and the additional view image from the combined image decoded by the base view decoder 550 using image interpolation.

The base view image and the additional view image can be finally reconstructed using the base view image sequence 592, the additional view image sequence 594, and the depth map sequence 596 reconstructed by the system 500.

The stereoscopic image format according to various exemplary embodiments of the present invention will now be described with reference to FIGS. 6A through 6C.

Referring to FIGS. 6A through 6C, the operations of the first YUV format generation unit 430, the second YUV format generation unit 440, the combined image extraction unit 470, and the depth map extraction unit 480 will be described additionally.

FIG. 6A illustrates images in a stereoscopic image format according to an exemplary embodiment of the present invention.

An image 610 illustrates a first YUV format image to be transmitted through a base channel.

An image 620 illustrates a Y region of a second YUV format image to be transmitted through an additional channel.

An image 630 illustrates UV regions of the second YUV format image to be transmitted through the additional channel.

The first YUV format generation unit 430 converts the combined image generated by the combined image generation unit 410 into a YUV format, thereby generating the first YUV format image 610.

The second YUV format generation unit 440 records the depth map generated by the depth map generation unit 420 in the Y region 620 of the second YUV format image and a specific value 128 or 0 in the U/V regions 630 of the second YUV format image, thereby generating the second YUV format image.

Similarly, during decoding, the combined image extraction unit 470 extracts the combined image from the first YUV format image 610 and the depth map extraction unit 480 extracts the depth map from the Y region 620 of the second YUV format image.

FIG. 6B illustrates images in a stereoscopic image format according to another exemplary embodiment of the present invention.

An image 640 illustrates a Y region of a second YUV format image to be transmitted through an additional channel.

An image 650 illustrates UV regions of the second YUV format image to be transmitted through the additional channel.

In general, depth map information has less variation than motion information and thus its usefulness does not degrade greatly even if its resolution is reduced. Thus, according to the first exemplary embodiment of the present invention, the second YUV format generation unit 440 reduces the width of the second YUV format image and the width of the depth map generated by the depth map generation unit 420 by ½ and records the reduced second YUV format image and depth map in the Y region 640 of the second YUV format image. Like the Y region 640 of the second YUV format image, the widths of the U/V regions 650 are also reduced by ½. In addition, according to other exemplary embodiments of the present invention, the second YUV format generation unit 440 may use various reduction patterns so that it may reduce only the height of the depth map by ½ or reduce both the height of and the width of the depth map by ½.

During decoding, the combined image extraction unit 470 extracts the combined image from the first YUV format image and the depth map extraction unit 480 extracts the depth map from the Y region of the second YUV format image. In an exemplary embodiment of the present invention, if the extracted depth map has reduced resolution, the depth map extraction unit 480 reconstructs the depth map by increasing the reduced resolution to the original resolution.

FIG. 6C illustrates images in a stereoscopic image format according to another exemplary embodiment of the present invention.

An image 660 illustrates a Y region of a reduced second YUV format image to be transmitted through an additional channel.

An image 670 illustrates UV regions of the reduced second YUV format image to be transmitted through the additional channel.

In an exemplary embodiment of the present invention, the second YUV format generation unit 440 reduces the width and height of the second YUV format image and the width and height of the depth map generated by the depth map generation unit 420 by ½ and records the reduced second YUV format image and the reduced depth map in the Y region 660 of the second YUV format image. Like the Y region 660 of the second YUV format image, the widths and depths of the U/V regions 670 are reduced by ½.

During decoding, the combined image extraction unit 470 extracts the combined image from the first YUV format image and the depth map extraction unit 480 extracts the depth map from the Y region of the second YUV format image. In an exemplary embodiment of the present invention, if the extracted depth map has reduced resolution, the depth map extraction unit 480 reconstructs the depth map by increasing the reduced resolution to the original resolution.

FIG. 7A is a block diagram of an apparatus 700 for encoding images in a stereoscopic image format according to a second exemplary embodiment of the present invention.

Referring to FIG. 7A, the apparatus 700 includes a depth map generation unit 710, a motion map generation unit 715, a differential image generation unit 720, a first YUV format generation unit 730, a second YUV format generation unit 740, and a transmission unit 750.

The depth map generation unit 710 receives a base view image and an additional view image, generates a depth map between the base view image and the additional view image, and outputs the depth map to the second YUV format generation unit 740.

In an exemplary embodiment of the present invention, the depth map generation unit 720 generates the depth map using a disparity vector obtained by disparity estimation between the base view image and the additional view image. In another exemplary embodiment of the present invention, the depth map is generated using a depth camera device.

In the second exemplary embodiment of the present invention, a disparity map may also be used in addition to the depth map generated using disparity estimation or the depth camera device.

The motion map generation unit 715 receives the base view image and the additional view image, generates a motion map of the additional view image, and outputs the motion map to the second YUV format generation unit 740.

In an exemplary embodiment of the present invention, the motion map generation unit 715 generates the motion map using a motion vector obtained by motion estimation between the base view image and the additional view image.

The differential image generation unit 720 receives the base view image and the additional view image, generates a differential image between the base view image and the additional view image, and outputs the differential image to the second YUV format generation unit 740.

In an exemplary embodiment of the present invention, the differential image generation unit 720 generates a differential image between the base view image obtained by encoding the base view image and then decoding the encoded base view image and the additional view image by considering an error between the base view image and a base view image that is previously decoded at a reception end during encoding.

The first YUV format generation unit 730 receives the base view image, generates a first YUV format image, and outputs the first YUV format image to the transmission unit 750.

The second YUV format generation unit 740 generates a second YUV format image using the depth map received from the depth map generation unit 710, the motion map received from the motion map generation unit 715, and the differential image received from the differential image generation unit 720, and outputs the second YUV format image to the transmission unit 750.

In an exemplary embodiment of the present invention, the second YUV format generation unit 740 determines one of the depth map and the motion map which has a smaller variance. If the variation of the depth map is smaller than that of the motion map, the second YUV format generation unit 740 generates the second YUV format image using the depth map. If the variation of the motion map is smaller than that of the depth map, the second YUV format generation unit 740 generates the second YUV format image using both the depth map and the motion map.

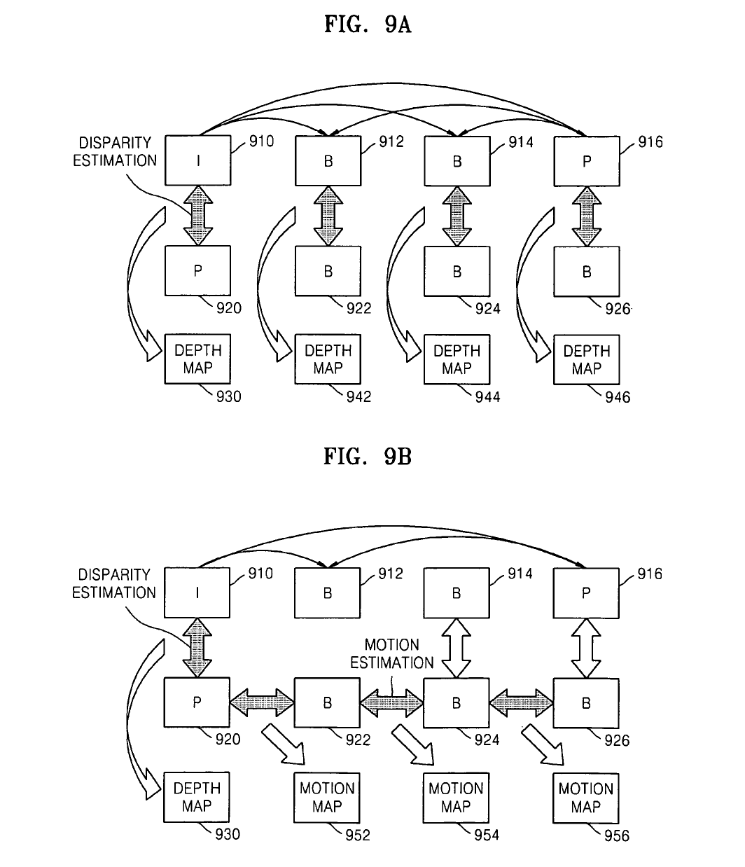

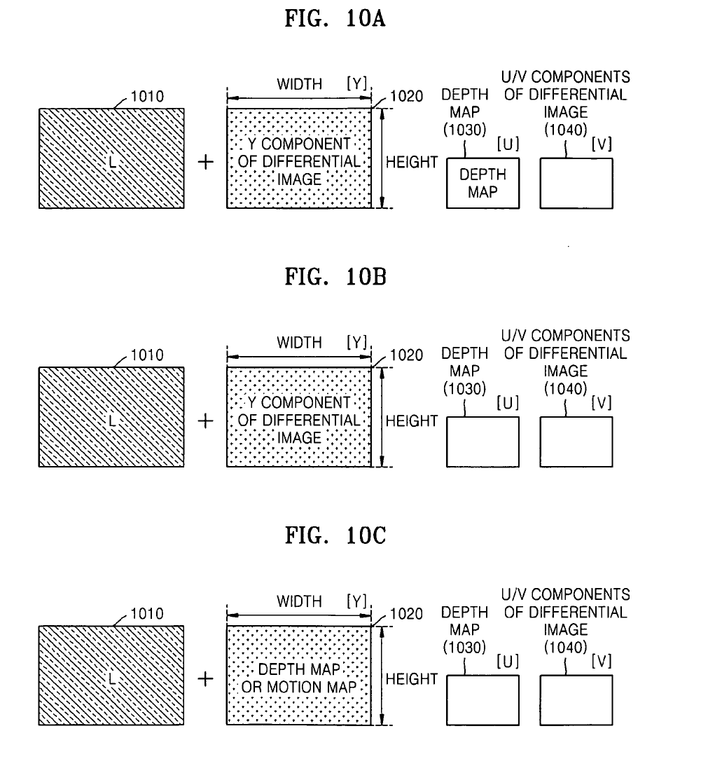

The operating principles of the first YUV format generation unit 730 and the second YUV format generation unit 740 will be described later in detail with reference to FIGS. 9A through 10C.

The transmission unit 450 transmits the first YUV format image input from the first YUV format generation unit 430 to a base channel and transmits the second YUV format image input from the second YUV format generation unit 440 to an additional channel.

FIG. 7B is a block diagram of an apparatus 760 for decoding an image in a stereoscopic image format according to the second exemplary embodiment of the present invention.

Referring to FIG. 7B, the apparatus 760 includes a first YUV format extraction unit 770, a second YUV format extraction unit 780, and a reconstruction unit 790.

The first YUV format extraction unit 770 extracts base view image information from a received first YUV format image and outputs the extracted base view image information to the reconstruction unit 490.

The second YUV format extraction unit 780 extracts differential image information between a base view image and an additional view image and a depth map between the base view image and the additional view image or a motion map of the additional view image from a second YUV format image and outputs the extracted differential image information and the extracted depth map or motion map to the reconstruction unit 490.

The operations of the first YUV format extraction unit 770 and the second YUV format extraction unit 780 will be described later in detail with reference to FIGS. 9A through 10C.

The reconstruction unit 490 reconstructs the base view image and the additional view image using the base view image information input from the first YUV format extraction unit 770 and the differential image information and the depth map or the motion map input from the second YUV format extraction unit 780 and outputs the reconstructed base view image and additional view image.

The detailed operating principle of the reconstruction unit 490 will be described later in detail with reference to FIGS. 9A and 9B.

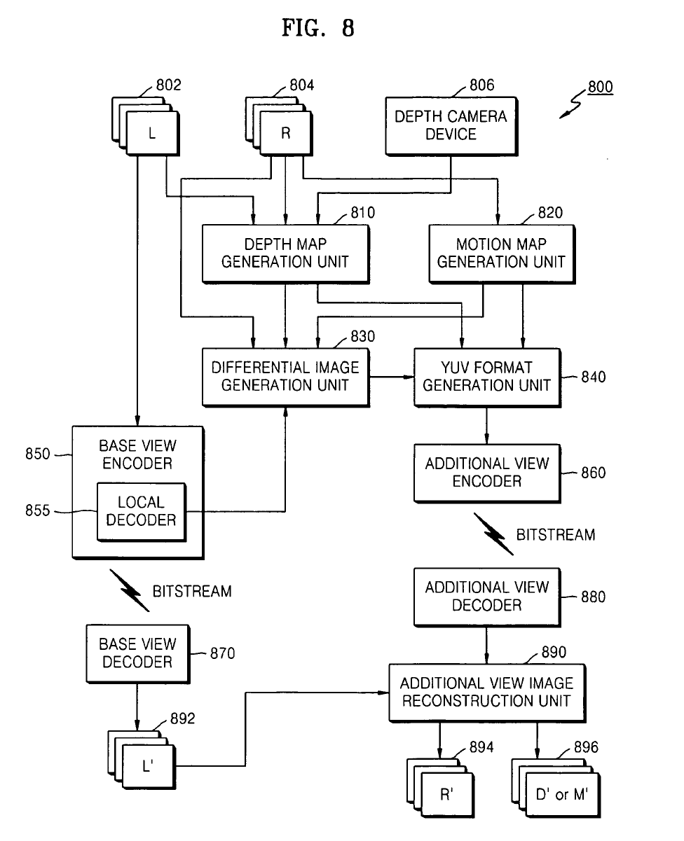

FIG. 8 illustrates a system 800 for transmitting and receiving a stereoscopic image format image according to the second exemplary embodiment of the present invention.

Referring to FIG. 8, the system 800 includes a depth map generation unit 810, a motion map generation unit 820, a differential image generation unit 830, a YUV format generation unit 840, a base view encoder 850, an additional view encoder 860, a base view decoder 870, an additional view decoder 880, and an additional view image reconstruction unit 890.

Some components of the system 800 correspond to some components of the apparatus 700 and the apparatus 760. In other words, the depth map generation unit 810 corresponds to the depth map generation unit 710, the motion map generation unit 820 corresponds to the motion map generation unit 715, the differential image generation unit 830 corresponds to the differential image generation unit 720, and the YUV format generation unit 840 corresponds to the second YUV format generation unit 740.

The system 800 may also use a conventional system for encoding and decoding stereoscopic images. In other words, a base view image of the system 800 is encoded by the base view encoder 530 of the conventional system and a second YUV format image generated by the YUV format generation unit 840 is encoded by the additional view encoder 860 of the conventional system.

However, the base view encoder 850 according to the second exemplary embodiment of the present invention includes a local decoder 855. The local decoder 855 temporally decodes the base view image encoded by the base view encoder 850 and outputs the decoded base view image to the differential image generation unit 830. The differential image generation unit 830 generates a differential image between the base view image decoded by the local decoder 855 and the additional view image, so as to prevent an error that may be discovered during decoding at a reception end.

Once the encoded base view image and the encoded second YUV format image are transmitted through channels allocated thereto, the base view image is decoded by the base view decoder 870 and the second YUV format image is decoded by the additional view decoder 880.

The additional view image reconstruction unit 890 reconstructs the additional view image and the depth map or the motion map using the decoded base view image, the decoded differential image, and the depth map or motion map.

FIG. 9A illustrates a relationship among the base view image, the additional view image, and the depth map according to an exemplary embodiment of the present invention.

Referring to FIG. 9A, the operating principles of the depth map generation unit 710, the second YUV format generation unit 740, and the reconstruction unit 790 will be described additionally.

Images 910, 912, 914, and 916 are frames of a base view image.

Images 920, 922, 924, and 926 are frames of an additional view image.

Images 930, 942, 944, and 946 are depth maps between the images 910 and 920, between the images 912 and 922, between the images 914 and 924, and between the images 916 and 926.

The depth map generation unit 710 generates the depth maps 930, 942, 944, and 946 by disparity estimation between the frames of the base view image and the additional view image.

In order to improve the transmission efficiency of the second YUV format image, the second YUV format generation unit 740 compares the variance of the depth map with the variance of the motion map. If the variance of the depth map is smaller than that of the motion map, the second YUV format generation unit 740 generates the second YUV format image using the depth maps 930, 942, 944, and 946 between the frames of the base view image and the additional view image.

FIG. 9B illustrates a relationship among the base view image, the additional view image, and the depth map according to another exemplary embodiment of the present invention.

Referring to FIG. 9B, the operating principles of the depth map generation unit 710, the second YUV format generation unit 740, and the reconstruction unit 790 will be described additionally.

An image 930 is a depth map between images 910 and 920.

Images 952, 954, and 956 are motion maps between images 920 and 922, between images 922 and 924, and between images 924 and 926.

The depth map generation unit 710 generates the depth map 930 by disparity estimation between the first frames of the base view image and the additional view image.

The motion map generation unit 720 generates the motion maps 952, 954, and 956 by disparity estimation between consecutive frames of the additional view image.

The second YUV format generation unit 740 compares the variance of the depth map with the variance of the motion map. If the variance of the motion map is smaller than that of the depth map, the second YUV format generation unit 740 generates the second YUV format image using the motion maps 952, 954, and 956 between consecutive frames of the additional view image.

However, since motion estimation cannot be performed between the first frame and its previous frame in a group of pictures (GOP) of the additional view image using an intra mode, a depth map obtained by disparity estimation between the first frame of a GOP of the base view image and the first frame of a GOP of the additional view image are used in the first frame of the second YUV format image.

Hereinafter, images in the stereoscopic image formats according to embodiments of the present invention will be described with reference to FIGS. 10A through 10C.

Referring to FIGS. 10A through 10C, the operations of the first YUV format generation unit 730, the second YUV format generation unit 740, the first YUV format extraction unit 770, and the second YUV format extraction unit 780 will be described additionally.

FIG. 10A illustrates images in a stereoscopic image format according to an exemplary embodiment of the present invention.

An image 1010 is a first YUV format image to be transmitted through a base channel.

An image 1020 is a Y region of a second YUV format image to be transmitted through an additional channel.

An image 1030 is a U region of the second YUV format image to be transmitted through the additional channel.

An image 1040 is a V region of the second YUV format image to be transmitted through the additional channel.

The first YUV format generation unit 730 converts an input base view image into a YUV format image for recording in the first YUV format image 1010. The first YUV format image 1010 is allocated to the base channel for transmission.

The second YUV format generation unit 740 records luminance information, i.e., a Y component, of the differential image generated by the differential image generation unit 720 in the Y region 1020 of the second YUV format image.

The second YUV format generation unit 740 records the depth map generated by the depth map generation unit 710 in the U region 1030 of the second YUV format image. As mentioned above, since there is not a great loss in accuracy in depth map information even if the resolution of the depth map information is reduced, the depth map information can be recorded in the U region 1030 of the second YUV format image.

The second YUV format generation unit 740 records chrominance information, i.e., U and V components, of the differential image generated by the differential image generation unit 720, in the V region 1040 of the second YUV format image.

In an exemplary embodiment of the present invention, the second YUV format generation unit 740 records the depth map in the V region 1040 of the second YUV format image and records the U and V components of the differential image in the U region 1030 of the second YUV format image.

FIG. 10B illustrates an image in a stereoscopic image format according to another exemplary embodiment of the present invention.

A process of the first YUV format generation unit 730 and a process of recording in the Y region of the second YUV format image by the second YUV format generation unit 740 are the same as in FIG. 10A.

However, in the current exemplary embodiment of the present invention, the second YUV format generation unit 740 records the depth map generated by the depth map generation unit 710 and the motion map generated by the motion map generation unit 720 in the U region 1030 of the second YUV format image. As mentioned above, the depth map is recorded only in the first picture of a GOP and the motion map is transmitted in the other pictures of the GOP.

The second YUV format generation unit 740 records chrominance information, i.e., U and V components of the differential image generated by the differential image generation unit 720 in the V region 1040 of the second YUV format image.

In an exemplary embodiment of the present invention, the second YUV format generation unit 740 records the depth map and the motion map in the V region 1040 of the second YUV format image and records the U and V components of the differential image in the U region 1030 of the second YUV format image.

FIG. 10C illustrates an image in a stereoscopic image format according to another exemplary embodiment of the present invention.

A process of the first YUV format generation unit 730 is the same as in FIGS. 10A and 10B.

However, in the current exemplary embodiment of the present invention, the second YUV format generation unit 740 records the depth map generated by the depth map generation unit 710 or the motion map generated by the motion map generation unit 715 in the Y region 1020 of the second YUV format image. As mentioned above, the variance of the depth map is compared with the variance of the motion map and the determined map is recorded in the Y region 1020 of the second YUV format image.

The second YUV format generation unit 740 records a Y component of the differential image generated by the differential image generation unit 720 in the U region 1030 of the second YUV format image.

The second YUV format generation unit 740 records U and V components of the differential image generated by the differential image generation unit 720 in the V region 1040 of the second YUV format image.

To decode the images in the stereoscopic image formats illustrated in FIGS. 10A through 10C, the first YUV format extraction unit 770 extracts the base view image from the first YUV format image 1010 and the second YUV format generation unit 780 extracts the differential image, the depth map, and the motion map from the second YUV format images 1020, 1030, and 1040 like in the encoding process.

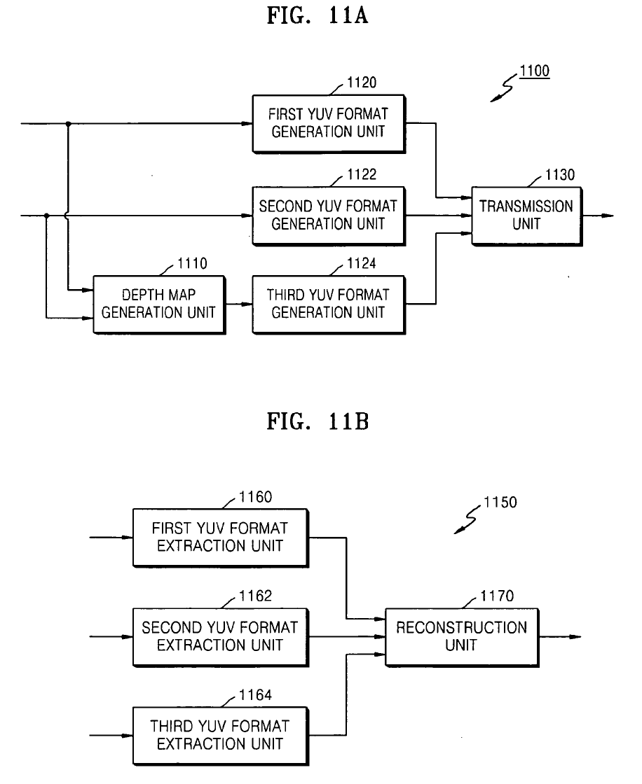

FIG. 11A is a block diagram of an apparatus 1100 for encoding an image in a stereoscopic image format according to a third exemplary embodiment of the present invention.

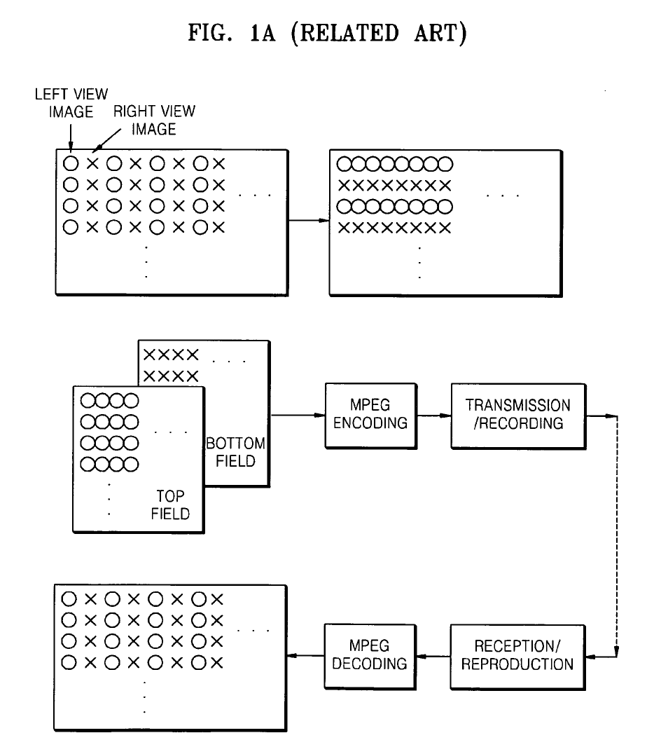

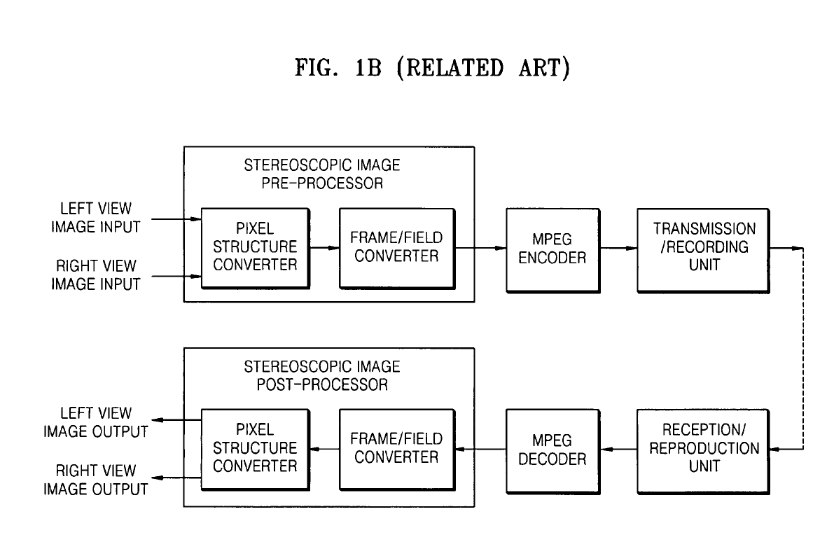

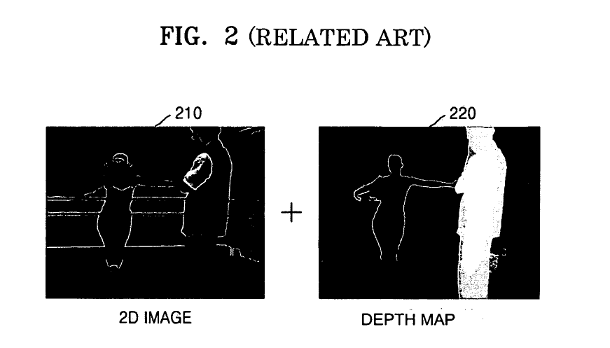

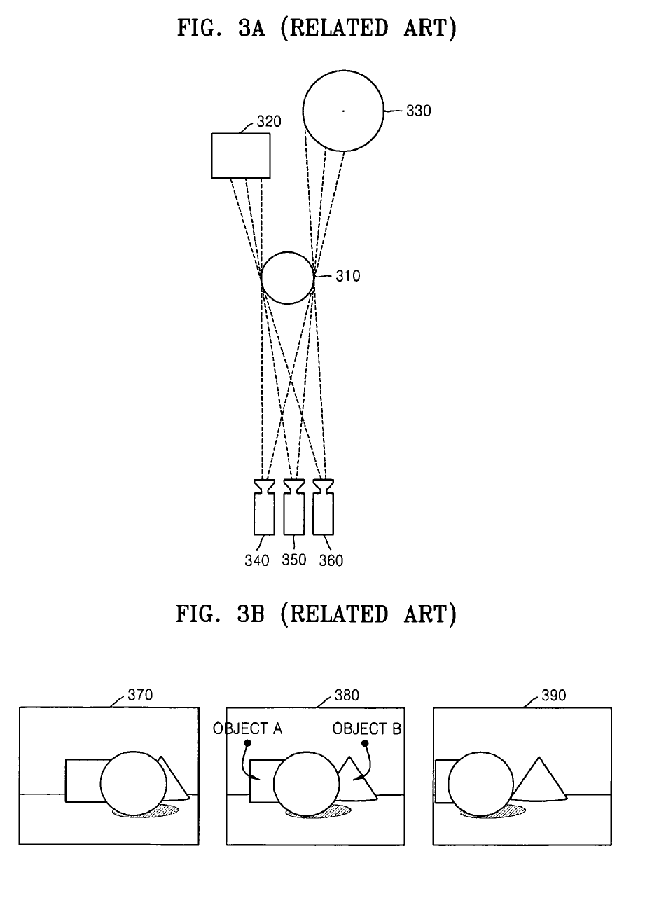

Referring to FIG. 1A, the apparatus 1100 includes a depth map generation unit 1110, a first YUV format generation unit 1120, a second YUV format generation unit 1122, a third YUV format generation unit 1124, and a transmission unit 1130.

The depth map generation unit 1110 receives a base view image and an additional view image, generates a depth map between the base view image and the additional view image, and outputs the generated depth map to the third YUV format generation unit 11124.

The first YUV format generation unit 1120 receives the base view image, generates a first YUV format image using the base view image, and outputs the first YUV format image to the transmission unit 1130.

The second YUV format generation unit 1122 receives the additional view image, generates a second YUV format image using the additional view image, and outputs the second YUV format image to the transmission unit 1130.

The third YUV format generation unit 1124 receives the depth map from the depth map generation unit 1110, generates the third YUV format image using the depth map, and outputs the third YUV format image to the transmission unit 1130.

The transmission unit 1130 receives the first YUV format image from the first YUV format generation unit 1120, the second YUV format image from the second YUV format generation unit 1122, and the third YUV format image from the third YUV format generation unit 1124 and allocates them to corresponding channels for transmission.

FIG. 11B is a block diagram of an apparatus 1150 for decoding an image in a stereoscopic image format according to the third exemplary embodiment of the present invention.

Referring to FIG. 11B, the apparatus 1150 includes a first YUV format extraction unit 1160, a second YUV format extraction unit 1162, a third YUV format extraction unit 1164, and a reconstruction unit 1170.

The first YUV format extraction unit 1160 receives the first YUV format image, extracts base view image information from the first YUV format image, and outputs the extracted base view image information to the reconstruction unit 1170.

The second YUV format extraction unit 1162 receives the second YUV format image, extracts additional view image information from the second YUV format image, and outputs the extracted additional view image information to the reconstruction unit 1170.

The third YUV format extraction unit 1164 receives the third YUV format image, extracts depth map from the third YUV format image, and outputs the extracted depth map to the reconstruction unit 1170.

The reconstruction unit 1170 reconstructs a base view image and an additional view image using the base view image information received from the first YUV format extraction unit 1160, the additional view image information received from the second YUV format extraction unit 1162, and the depth map received from the third YUV format extraction unit 1164.

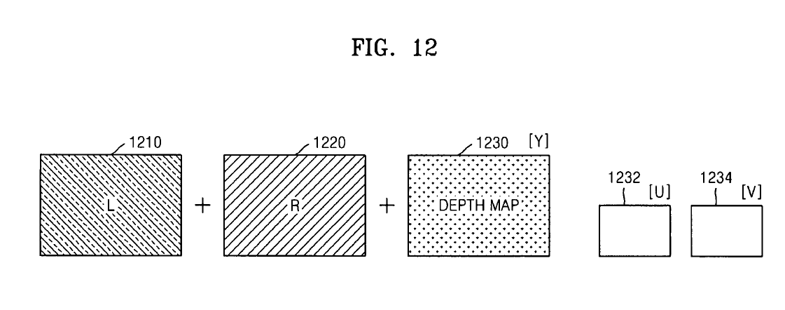

FIG. 12 illustrates an image in a stereoscopic image format according to an exemplary embodiment of the present invention.

The operating principles of the first YUV format generation unit 1120, the second YUV format generation unit 1122, the third YUV format generation unit 1124, the first YUV format extraction unit 1160, the second YUV format extraction unit 1162, and the third YUV format extraction unit 1164 will be described in detail with reference to FIG. 12.

An image 1210 is a first YUV format image to be transmitted through a base channel.

An image 1220 is a second YUV format image to be transmitted through a first additional channel.

An image 1230 is a Y region of a third YUV format image to be transmitted through a second additional channel.

An image 1232 is a U region of the third YUV format image to be transmitted through the second additional channel.

An image 1234 is a V region of the third YUV format image to be transmitted through the second additional channel.

The first YUV format generation unit 1120 converts the base view image into a YUV format image for recording in the first YUV format image 1210.

The second YUV format generation unit 1122 converts the additional view image into a YUV format image for recording in the second YUV format image 1220.

The third YUV format generation unit 1124 records the depth map input from the depth map generation unit 1110 in the Y region 1230 of the third YUV format image.

The third YUV format generation unit 1124 records a specific value 128 or 0 in the U region 1232 and the V region 1234 of the third YUV format image.

As mentioned above, since there is not a great loss in accuracy in the depth map even if the resolution of the depth map is reduced, the third YUV format generation unit 1124 can reduce the width or height of the third YUV format image by ½.

During decoding according to the current exemplary embodiment of the present invention, the first YUV format extraction unit 1160 extracts base view image information from the first YUV format 1210, the second YUV format extraction unit 1162 extracts additional view image information from the second YUV format 1220, and the third YUV format extraction unit 1164 extracts the depth map from the Y region 1230 of the third YUV format image.

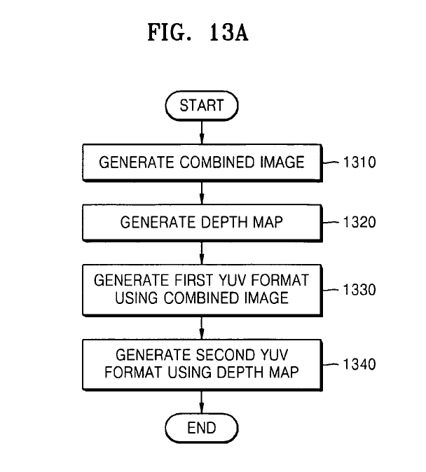

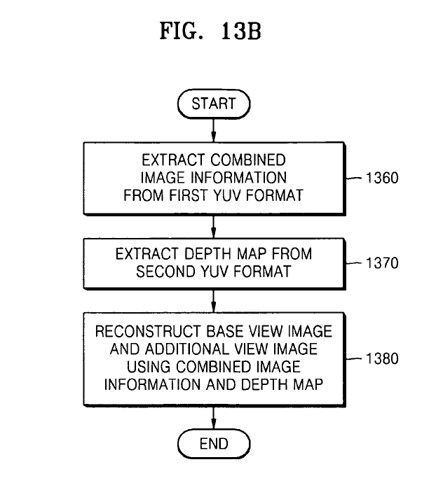

FIG. 13A is a flowchart illustrating a method of encoding an image in a stereoscopic image format according to the first exemplary embodiment of the present invention.

In operation 1310, a combined image is generated by combining an input base view image with an input additional view image.

In operation 1320, a depth map between the input base view image and the input additional view image. In an exemplary embodiment of the present invention, the depth map is generated by disparity estimation between the base view image and the additional view image or using a depth camera device.

In operation 1330, a first YUV format image is generated using the combined image generated in operation 1310.

In operation 1340, a second YUV format image is generated using the depth map generated in operation 1320. In an exemplary embodiment of the present invention, the depth map is recorded in a Y region of the second YUV format image.

FIG. 13B is a flowchart illustrating a method of decoding an image in a stereoscopic image format according to the first exemplary embodiment of the present invention.

In operation 1360, combined image information composed of a base view image and an additional view image is extracted from a received first YUV format image.

In operation 1370, a depth map between the base view image and the additional view image is extracted from a received second YUV format image.

In operation 1380, the base view image and the additional view image are reconstructed using the combined image information extracted in operation 1360 and the depth map extracted in operation 1370.

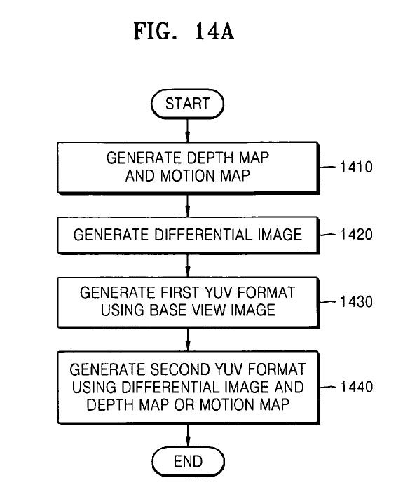

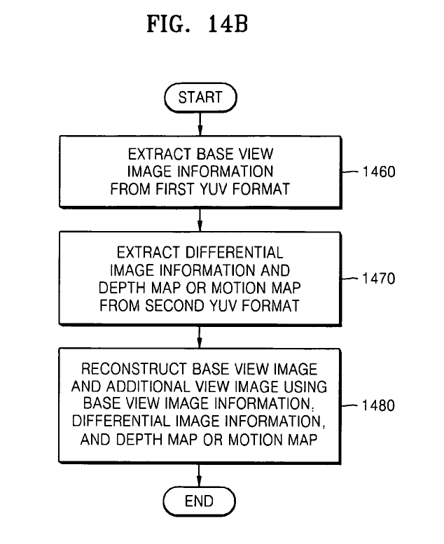

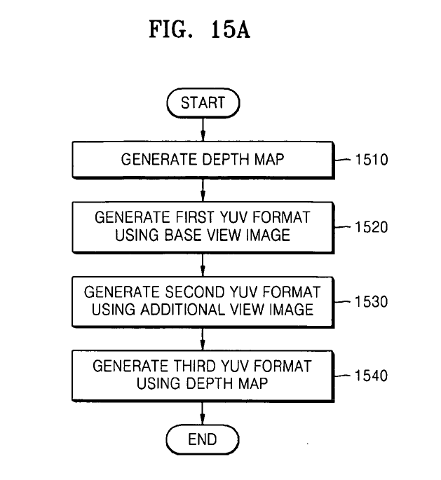

FIG. 14A is a flowchart illustrating a method of encoding an image in a stereoscopic image format according to the second exemplary embodiment of the present invention.

In operation 1410, a depth map between an input base view image and an input additional view image is generated and a motion map of the input additional view image is generated.

In operation 1420, a differential image between the input base view image and the input additional view image is generated.

In operation 1430, a first YUV format image is generated using the input base view image.

In operation 1440, a second YUV format image is generated using the differential image generated in operation 1420 and the depth map or the motion map generated in operation 1410. In an exemplary embodiment of the present invention, one of a Y component of the differential image and the depth map is recorded in a Y region of the second YUV format image and the other is recorded in a U or V region of the second YUV format image. In an exemplary embodiment of the present invention, U and V components of the differential image are recorded in the U or V region of the second YUV format image.

FIG. 14B is a flowchart illustrating a method of decoding an image in a stereoscopic image format according to the second exemplary embodiment of the present invention.

In operation 1460, base view image information is extracted from a received first YUV format image.

In operation 1470, differential image information between a base view image and an additional view image, and a depth map between the base view image and the additional view image or a motion map of the additional view image are extracted from a received second YUV format image.

In an exemplary embodiment of the present invention, one of a Y component of a differential image and the depth map is extracted from a Y region of the second YUV format image and the other is extracted from a U or V region of the second YUV format image. In an exemplary embodiment of the present invention, U and V components of the differential image are extracted from a U or V region of the second YUV format image.

In operation 1480, the base view image and the additional view image are reconstructed using the base view image information extracted in operation 1460, the differential image information extracted in operation 1470, and the depth map or the motion map extracted in operation 1470.

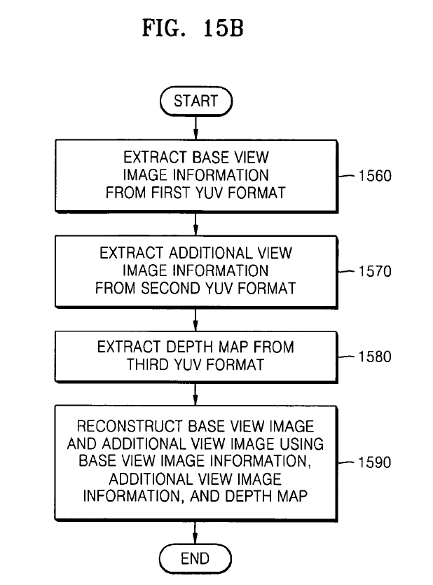

FIG. 15A is a flowchart illustrating a method of encoding an image in a stereoscopic image format according to the third exemplary embodiment of the present invention.

In operation 1510, a depth map between an input base view image and an input additional view image is generated. In an exemplary embodiment of the present invention, the depth map is generated by disparity estimation between the base view image and the additional view image or using a depth camera device.

In operation 1520, a first YUV format image is generated using the input base view image.

In operation 1530, a second YUV format image is generated using the input additional view image.

In operation 1540, a third YUV format image is generated using the depth map generated in operation 1510. In an exemplary embodiment of the present invention, the depth map is recorded in a Y region of the third YUV format image.

FIG. 15B is a flowchart illustrating a method of decoding an image in a stereoscopic image format according to the third exemplary embodiment of the present invention.

In operation 1560, base view image information is extracted from a received first YUV format image.

In operation 1570, additional view image information is extracted from a received second YUV format image.

In operation 1580, a depth map is extracted from a received third YUV format. In an exemplary embodiment of the present invention, the depth map is extracted from a Y region of the third YUV format.

In operation 1590, a base view image and an additional view image are reconstructed using the base view image information extracted in operation 1560, the additional view image information extracted in operation 1570, and the depth map extracted in operation 1580.

According to the present invention, by transmitting both information of all views of stereoscopic images and disparity/depth information, a decoding end can accurately reconstruct a base view image and an additional view image.

Moreover, since image information of at least one views are transmitted and received, an occlusion region from a certain view can be obtained from another view, thereby improving the display quality of reconstructed stereoscopic images.

Furthermore, a combined image is generated by combining a base view image and an additional view image and its resolution is the same as that of the base view image and the additional view image, thereby improving transmission efficiency without increasing the number of transmission channels. Transmission efficiency can be further improved by the use of a differential image between the base view image and an additional view image and the reduction of the resolution of a depth map.

In addition, motion information of the additional view image as well as disparity/depth information between the base view image and the additional view image is used, thereby allowing efficient encoding.

Meanwhile, the embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), and optical recording media (e.g., CD-ROMs, or DVDs). In a exemplary embodiment, the recording medium may include storage media such as carrier waves (e.g., transmission through the Internet).

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A method of encoding an image in a stereoscopic image format, the method comprising:
generating a combined image by combining a first view image and a second view image;
generating a depth map between the first view image and the second view image;
generating a first format image based on the combined image; and
generating a second format image based on the depth map, wherein the first and the second format images are of a color space.

2. The method of claim 1, wherein the combined image comprises pixel information of the first view image and pixel information of the second view image, and a resolution of the first view image, a resolution of the second view image and a resolution of the combined image are the same.

3. The method of claim 1, wherein the generating of the second format image comprises:
recording the depth map in a luminance region of the second format image; and
recording a value of 128 or 0 in a chrominance region of the second format image.

4. The method of claim 3, wherein the generating of the second format image comprises reducing a resolution of the luminance region, a resolution of a first chrominance region, and a resolution of a second chrominance region of the second format image by ½ in a horizontal direction or in a vertical direction.

5. A method of encoding an image in a stereoscopic image format, the method comprising:
generating a depth map between a first view image and a second view image, and a motion map of the second view image;
generating a differential image between the first view image and the second view image;
generating a first format image based on the first view image; and
generating a second format image based on the differential image and the depth map or the motion map,
wherein the first and the second format images are in a color space.

6. The method of claim 5, wherein the generating of the differential image comprises generating a differential image between a first view image obtained by encoding the first view image and then decoding the encoded first view image, and the second view image.

7. The method of claim 5, wherein the generating of the second format image comprises:
determining which one of a variance of the depth map and a variance of the motion map is smaller;
generating the second format image based on the depth map if the variance of the depth map is determined to be smaller;
generating a first frame of the second format image based on a depth map between a first frame of the first view image and a first frame of the second view image; and
generating a plurality of remaining frames of the second format image based on a motion map of a plurality of remaining frames of the second view image.

8. The method of claim 5, wherein the generating of the second format image comprises:
recording luminance information, of the differential image in a luminance region of the second format image;
recording a depth map or a motion map in one of a first chrominance region and a second chrominance region of the second format image; and
recording chrominance information of the differential image in another of the first and the second chrominance regions of the second format image,
wherein the luminance, the first chrominance and the second chrominance regions correspond to components of the color space.

9. The method of claim 5, wherein the generating of the second format image comprises:
recording the depth map or the motion map in a luminance region of the second format image;
recording luminance information of the differential image in one of a first chrominance region and a second chrominance region of the second format image;
recording chrominance information of the differential image in another of the first chrominance region and the second chrominance region of the second format image; and
the luminance, the first and second chrominance regions correspond to components of the color space.

10. A method of encoding an image in a stereoscopic image format, the method comprising:
generating a depth map between a first view image and a second view image;
generating a first format image based on the first view image;
generating a second format image based on the second view image; and
generating a third format image based on the depth map,
wherein the first, the second and the third format images are of a color space.

11. The method of claim 10, wherein the generating of the third format image comprises:
recording the depth map in a luminance region of the third format image; and
recording a value of 128 or 0 in a first chrominance region and a second chrominance region of the third format image,
wherein the luminance, the first and second chrominance regions correspond to components of the color space.

12. A method of decoding an image in a stereoscopic image format, the method comprising:
extracting combined image information comprising a first view image and a second view image from a received first format image;
extracting a depth map between the first view image and the second view image from a received second format image; and
reconstructing the first view image and the second view image based on the extracted combined image information and the extracted depth map,
wherein the first and the second format images are of a color space.

13. The method of claim 12, wherein the extracting of the depth map comprises:
if the second format image is a reduced format, increasing a resolution of the second format image to an original resolution; and
extracting the depth map from a first region of the second format image,
wherein the first region corresponds to a luminance region.

14. The method of claim 12, wherein the reconstructing of the first view image and the second view image comprises:
reconstructing fractional information of the first view image and fractional information of the second view image from the extracted combined image information; and
reconstructing the first view image and the second view image to an original resolution based on the reconstructed fractional information of the first view image, the reconstructed fractional information of the second view image, and the depth map.

15. A method of decoding an image in a stereoscopic image format, the method comprising:
extracting first view image information from a received first format image;
extracting differential image information between a first view image and a second view image and a depth map between the first view image and the second view image or a motion map of the second view image, from a received second format image; and
reconstructing the first view image and the second view image based on the extracted first view image information, and the extracted differential image information, and the extracted depth map or motion map.

16. The method of claim 15, wherein the extracting from the second format image comprises:
extracting luminance information of the differential image information from a luminance region of the second format image;
extracting the depth map or the motion map from one of a first chrominance region and a second chrominance region of the second format image; and
extracting chrominance information from another one of the first and the second chrominance regions of the second format image.

17. The method of claim 15, wherein the extraction from the second format image comprises:
extracting the depth map or the motion map from a luminance region of the second format image;
extracting luminance information of the differential image information from one of a first chrominance region and a second chrominance region of the second format image; and
extracting chrominance information of the differential image information from another of the first and the second chrominance regions of the second format image.

18. The method of claim 15, wherein the reconstructing of the first view image and the second view image comprises:
if only the depth map is received, reconstructing the second view image based on the depth map and the extracted first view image information; and
if the depth map and the motion map are received, reconstructing a first frame of the second view image based on the depth map and a first frame of the extracted first view image information and reconstructing other frames of the second view image based on the motion map and the reconstructed first frame of the second view image.

19. A method of decoding an image in a stereoscopic image format, the method comprising:
extracting first view image information from a received first format image;
extracting second view image information from a received second format image;
extracting a depth map from a received third format image; and
reconstructing a first view image and a second view image based on the extracted first view image information, the extracted second view image, and the extracted depth map,
wherein the first, the second and the third format images are of a color space.

20. The method of claim 19, wherein the extraction from the third format image comprises extracting the depth map from a luminance region of the third format image, the luminance region corresponding to one component of the color space.

21. An apparatus for encoding an image in a stereoscopic image format, the apparatus comprising:
a combined image generation unit which generates a combined image by combining a first view image and a second view image;
a depth map generation unit which generates a depth map between the first view image and the second view image;
a first format generation unit which generates a first format image based on the combined image; and
a second format generation unit which generates a second format image based on the depth map,
wherein the first and the second format images are of a color space.

22. The apparatus of claim 21, wherein the second format generation unit records the depth map in a luminance region of the second format image and records a value of 128 or 0 in a first chrominance region and a second chrominance region of the second format image, the luminance, the first and second chrominance regions corresponding to components of the color space.

23. An apparatus for encoding an image in a stereoscopic image format, the apparatus comprising:
a depth map/motion map generation unit which generates a depth map between a first view image and a second view image and a motion map of the second view image;
a differential image generation unit which generates a differential image between the first view image and the second view image;
a first format generation unit which generates a first format image based on the first view image; and
a second format generation unit which generates a second format image based on the differential image and the depth map or the motion map, wherein the first and the second format images are of a color space.

24. The apparatus of claim 23, further comprising a local decoder, wherein the differential image generation unit generates the differential image between a first view image obtained by encoding the first view image and then decoding the encoded first view image based on the local decoder, and the second view image.

25. The apparatus of claim 23, wherein the second format generation unit records luminance information of the differential image in a luminance region of the second format image, records the depth map or the motion map in one of a first chrominance region and a second chrominance region of the second format image, and records chrominance information of the differential image in another of the first and the second chrominance regions of the second format.

26. An apparatus for encoding an image of a stereoscopic image format, the apparatus comprising:
a depth map generation unit which generates a depth map between a first view image and a second view image;
a first format generation unit which generates a first format image based on the first view image;
a second format generation unit which generates a second format image based on the second view image; and
a third format generation unit which generates a third format image based on the depth map,
wherein the first, the second and the third format images are of a color space.

27. An apparatus for decoding an image of a stereoscopic image format, the apparatus comprising:
a combined image extraction unit which extracts combined image information comprising a first view image and a second view image from a received first format image;
a depth map extraction unit extracting a depth map between the first view image and the second view image from a received second format image; and
a reconstruction unit which reconstructs the first view image and the second view image based on the extracted combined image information and the extracted depth map,
wherein the first and the second format images are of a color space.

28. The apparatus of claim 27, wherein, if the second format image is of a reduced format, the depth map extraction unit increases a resolution of the second format image to an original resolution and extracts the depth map from a luminance region of the second format image.

29. An apparatus for decoding an image in a stereoscopic image format, the apparatus comprising:
a first format extraction unit which extracts a first view image information from a received first format image;
a second format extraction unit which extracts differential image information between a first view image and a second view image and a depth map between the first view image and the second view image or a motion map of the second view image from a received second format image; and
a reconstruction unit which reconstructs the first view image and the second view image based on the extracted first view image information, the extracted differential image information, and the extracted depth map or motion map,
wherein the first and the second format images are in a color space.

30. The apparatus of claim 29, wherein the second format extraction unit extracts luminance information of the differential image information from a luminance region of the second format image, extracts the depth map or the motion map from one of a first chrominance region and a second chrominance region of the second format image, and extracts chrominance information from another of the first and the second chrominance regions of the second format image.

31. An apparatus for decoding an image in a stereoscopic image format, the apparatus comprising:
a first format extraction unit which extracts a first view image information from a received first format image;
a second format extraction unit which extracts second view image information from a received second format image;
a third format extraction unit which extracts a depth map from a received third format image; and
a reconstruction unit which reconstructs a first view image and a second view image based on the extracted first view image information, the extracted second view image, and the extracted depth map,
wherein the first, the second and the third format images are in a color space.

32. The apparatus of claim 31, wherein the third format extraction unit extracts the depth map from a luminance region of the third format image.

33. A computer-readable recording medium having recorded thereon a program for executing the method of claim 1.

34. A computer-readable recording medium having recorded thereon a program for executing the method of claim 5.

35. A computer-readable recording medium having recorded thereon a program for executing the method of claim 10.

36. A computer-readable recording medium having recorded thereon a program for executing the method of claim 12.

37. A computer-readable recording medium having recorded thereon a program for executing the method of claim 15.

38. A computer-readable recording medium having recorded thereon a program for executing the method of claim 19.

39. The method of claim 12, wherein the color space is a YUV color space.

40. The apparatus of claim 27, wherein the color space is a YUV color space.
